(19) United States
(12) Patent Application Publication
(10) Pub. No.: US 2007/0186709 A1
(43) Pub. Date: Aug. 16, 2007

(54) Rotation drive

(76) Inventor: Franz Schwendemann, Ottersweier (DE)

Correspondence Address: MERCHANT & GOULD PC, P.O. BOX 2903, MINNEAPOLIS, MN, 55402-0903, US

(21) Appl. No.: 10/591,627

(22) PCT Filed: Feb. 1, 2005
(86) PCT No.: PCT/EP05/50429

§ 371 Date: Sep. 5, 2006

(30) Foreign Application Priority Data
Mar. 12, 2004 (DE) 10 2004 012 076.5

(51) Int. Cl. F16H 1/16

(52) U.S. Cl. 74/425

(57) ABSTRACT

A rotation drive, particularly for displacing a moveable part in a motor vehicle, comprising a rotor which is mounted in a housing and which whose front-surface side rests upon a support element which is fixed to the housing in a positive fit. The support element is provided with radial linking elements which can be self-furrowingly rotated into the housing.

### FIELD OF THE INVENTION

The invention concerns a rotary drive with a supporting member for a rotor according to the class of the independent claim.

### BACKGROUND

From the German patent DE 31 505 72 A1 a drive unit was made known, in which the manufacturing tolerances between the armature spindle and the housing which supports it were eliminated by means of an adjusting screw. In so doing, the housing has an internal thread in which the adjusting screw engages by means of an external thread. To compensate for the play in the armature spindle, the adjusting screw with a stop face is turned at a predetermined amount of force against the front (end) face of the rotor shaft.

In such a device, the forming of a thread on the housing as well as on the adjusting screw is relatively painstaking. Furthermore, after adjusting to a predefined amount of force a further step of work is necessary for a torque proof fixing of the adjusting screw. For example, the screw is glued securely or an additional retaining element is installed.

### SUMMARY

The device according to the invention with the characteristics of the independent claim 1 has the advantage, that through the design of self-cutting crosspieces on the supporting member, this member can be fixed in a borehole of the housing in a one-step process. In so doing, the forming of internal threads in the housing section as well as the additional fixing of the supporting member from turning, which requires an additional step of work, are eliminated. Hence by means of a single component part an axial adjustment to the armature is achieved, which is free of play and self-supporting. It is also capable of supporting large axial forces to the armature.

Advantageous modifications of the device according to the independent claim are possible by means of the measures which are listed in the sub-claims. If the radial crosspieces are arranged on the outer edge of a cylindrical base plate of the supporting member, the crosspieces then form a form closure with the housing section which surrounds the base plate. Through the choice of the radial length of the crosspieces, the area of overlapping diameters between the crosspieces and the borehole of the housing is adjusted to fit the axial forces arising from the armature. The radial crosspieces are thereby advantageously arranged when they approach being vertical to the cylinder axis. In contrast to the threads of an adjusting screw, the crosspieces have no thread lead across their circumference. Therefore, when an axial force acts upon the supporting member, no parts of this force result in a circumferential direction. Thus, these radial crosspieces represent a reliable security against twisting. Moreover, an undesirable axial displacement from turning an adjustment screw in is avoided.

If the radial crosspieces are designed as angular segments around the base plate, which neither touch nor overlap, these crosspieces during installation of the supporting member can be axially inserted in a simple procedure into corresponding radial recesses of the housing borehole. By turning the supporting member to an angle which corresponds to the amount of angular displacement of the angular segment crosspieces (or somewhat more), the crosspieces cut into the housing material between its radial recesses, whereby an axial support of the armature is achieved.

Depending upon the diameter of the base plate of the supporting member and the amount of axial forces present acting on the supporting member, two or three crosspieces which respectively lie across from each other—or three or more—can be molded symmetrically across the circumference of the base plate. In so doing, a corresponding number of preferably kidney-shaped radial recesses are formed, in which the respective crosspieces are to be inserted during installation.

In a further embodiment of the rotary drive according to the invention, the radial crosspieces are arranged on the supporting member in planes which are axially separated from one another and which approximately run vertical to the cylinder axis. Thereby, the two or more radial crosspieces per plane lie respectively in the same angular range as the radial crosspieces of the next plane, so that the radial crosspieces of the various planes upon installation can be respectively inserted axially into the same radial recess of the housing.

If the housing in the area of the front (end) face of the rotor shaft has a through hole on whose circumference radial recesses have been formed in sections, the supporting member can be axially inserted into the through hole with a predetermined contact pressing force and then pressed against the front face of the rotor shaft. By turning the supporting member around a certain angular range, a form closure occurs between the crosspieces, which create their own chamfers (fluting), and the housing. The supporting member is, thus, stabilized against axial displacement and twisting.

In addition to this, the housing of the rotary drive is manufactured from plastic or at least soft metal in the area of the borehole. Thereby the radial crosspieces which are preferably manufactured from hard metal—for instance steel—can penetrate into the injection die cast or pressure die cast housing using a relatively minimal turning force.

In so doing, it is advantageous for the crosspieces to have a sharp, self-chamfering cutting edge along that edge with which they engage the housing section when a twisting of the supporting member occurs. Such a twisting results in the radial crosspieces cutting a corresponding chamfer in the housing section. In order to secure the supporting member against a counter rotation during operation, security areas are formed in an additional edge lying directly across from the initial inner housing wall. These could, for example be designed in the form of a ridge, which would grab into the walls of the carved out chamfers in the housing at the occurrence of a counter rotation of the supporting member.

In a further embodiment, the front (end) face of the rotor, particularly that of the rotor shaft, is designed spherical, so that this front face has a certain radius. If the rotor supports itself by way of such an arched front face at a flat stop face of the supporting member, the friction in the rotational operation of the rotor can be greatly reduced, whereby the degree of effectiveness is increased.

For ease in installation, the supporting member has a form-closed entrainment member which positively locks with an installation tool in order to turn the supporting element in the borehole of the housing.

### BRIEF DESCRIPTION OF THE DRAWINGS

Various examples of embodiment of a device according to the invention are depicted in the drawings and are explained in more detail in the following description. They show:

FIG. 1

A section of a rotary drive with a supporting member according to the invention

FIG. 2

A further embodiment example of a rotary drive in the same kind of sectional depiction

FIG. 3

A top view according to III of the rotary drive from FIG. 2 and

FIG. 4

An additional embodiment of a supporting element in an uninstalled state

### DESCRIPTION

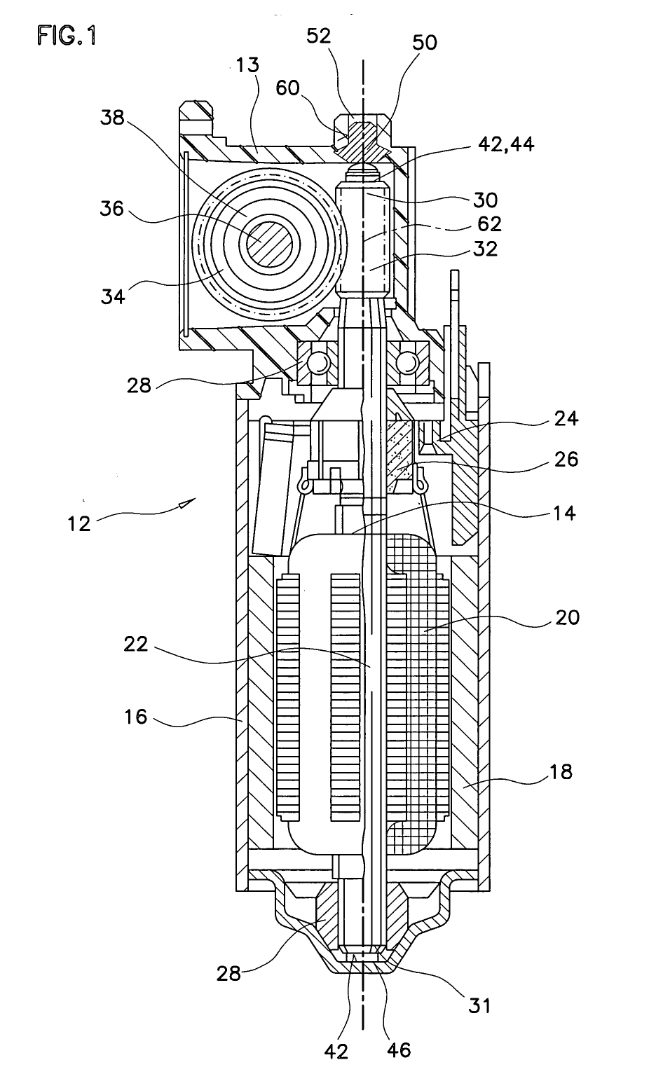

In FIG. 1 an electromotor 10 is depicted as a rotary drive 10, that has a rotor 14 positioned with a bearing in a housing 12. The housing 12 has, for example, a pole pot 16 forming a housing section 13, in which permanent magnets 18 are located. These magnets work together with electrical coils 20, which are located on the rotor shaft 22 of the rotor 14. A collector (commutator) 24 is furthermore located on the rotor shaft 22 for commutation of the electrical coils 20. The collector 24 is supplied with current via brushes 24 which are located on a housing 12. Ball and roller bearings 28 are located on the rotor shaft 22, with which the rotor shaft 22 is at least radially positioned. At one end 30 of the rotor shaft 22 a worm 32 is positioned on it, which engages with a worm wheel 34. The worm wheel 34 is, for example, positioned on a securely anchored pin and is connected to an output link 38 which, for example, adjusts seat sections of a motor vehicle seat. During the power transfer from the worm 32 on the shaft to the worm wheel 34 via the engagement of the teeth, an axial force acts on the rotor shaft 22, which (depending upon the direction of rotation of the electromotor 10 in FIG. 1) is directed up or down. The rotor 14 has, therefore, front faces 42 at both ends 30, 31 of the rotor shaft 22, which, for example are formed as one piece on the rotor shaft 22. These also are, for example, designed through material molding as arched spherical ends with a radius 44. The rotor 14 supports itself on one end 31 directly on the inside wall of the housing 12 and with the other end 30 on a separate supporting member 50, which is attached to the housing 12. After the installation of the drive 10, the supporting member 50 is pressed through a through hole 52 in the housing 12 axially against the front (end) face 42, so that this face 42 comes to rest on the stop face 56 of the supporting member 50 at a predetermined contact pressing force 54. Tolerances due to manufacture can, therefore, be compensated for between the rotor shaft 22 and the housing 12 which is assembled from different housing sections 13. In order to fix the supporting member 50 axially, it has radial crosspieces 58 formed to a base plate 66. These mesh as a form closure into a wall 60 of the borehole 52. The radial crosspieces 58, which are grouped approximately around a cylindrical axis 62 of the base plate 66, that is respectively around the rotor shaft 22, have a self-cutting edge 64 with which the radial crosspieces 58 cut into the material of the housing 12.

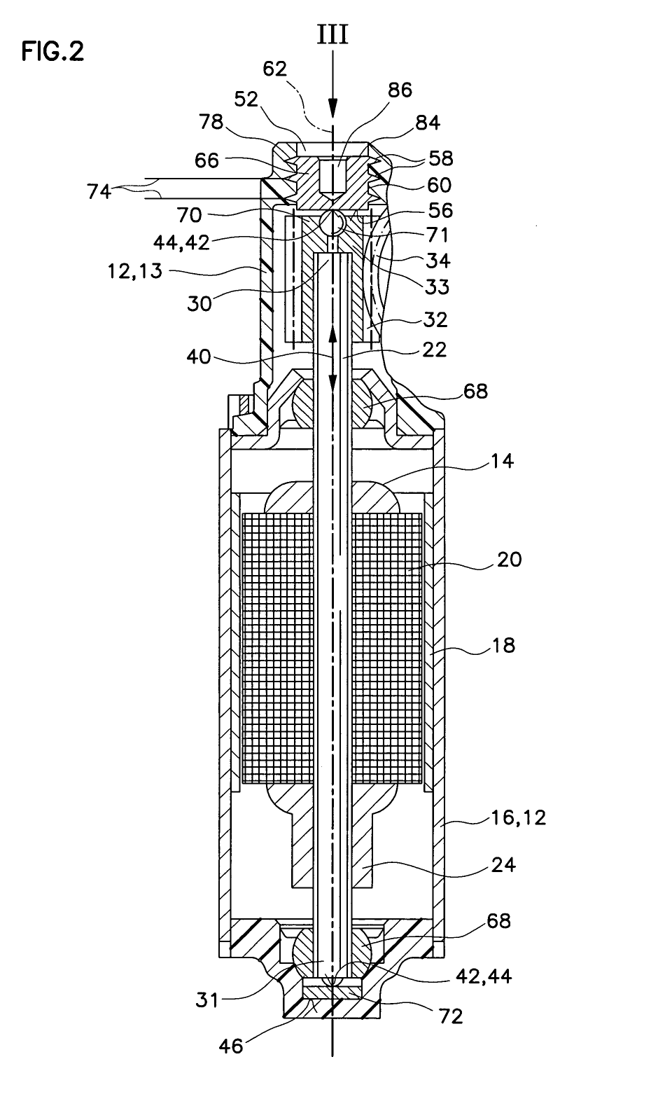

FIG. 2 shows an enlarged depiction of an additional embodiment example of an electromotor 10, in which the rotor shaft 22 is positioned in the housing 12 by means of a cup and ball bearing 68. The collector 24, which is hereby only schematically depicted, is positioned between the electric coils 22 and the bottom end of the pole housing 16. In an alternative embodiment the electromotor 10 can also be electrically commutated. A worm 32 designed as a separate component part is fixed in a torque proof manner to the end 30 of the rotor shaft 22. It in turn meshes with a worm wheel 34, which is only partially depicted. The worm 32 has a head 33, on which the axial end 30 of the rotor shaft 22 supports itself, so that the connection between the worm 32 and the rotor shaft 22 must absorb only torsional and no axial forces. At an end 70 of the worm 32, respectively of the head 33, a sphere 71 with a radius 44 is located. The rotor 14 supports itself with the sphere 71 on the stop face 56 of the supporting member 50. Consequently the axial forces 40 which arise from the force transfer between the worm 32 and the worm wheel 34—analogous with those as in the embodiment according to FIG. 1—are supported on the one side by way of the two front (end) faces 42 on the housing 12 (via a washer disc 72) and on the other side on the axially adjustable stop face of the supporting member 50. In this connection the self-chamfering (self-fluting) radial crosspieces are arranged in three planes spaced from each other and running approximately vertical to the cylinder axis 62. In contrast to the threads of an adjusting screw, the radial crosspieces 58 have no thread lead across their circumference. When the self-cutting radial crosspieces 58 are turned into the inner wall 60 of the housing section 13, no spiral shaped thread turns emerge, but on the contrary separate ring-shaped chamfers 78, that respectively lie completely in a plane 74 with a constant surface (face) benchmark (norm). The supporting member 50 has a cylindrical base plate 66, that closes on one side the through hole 52 in the housing 12. On an outer circumference 82 of the base plate 66, the radial crosspieces 58 are preferably formed as one piece. On the side opposite to the stop face 56 the supporting member 50 has an entrainment member 86, in which, for example, a tool with an outside polyhedron head could positively lock in order to turn the supporting member 50 to a particular angle range during installation.

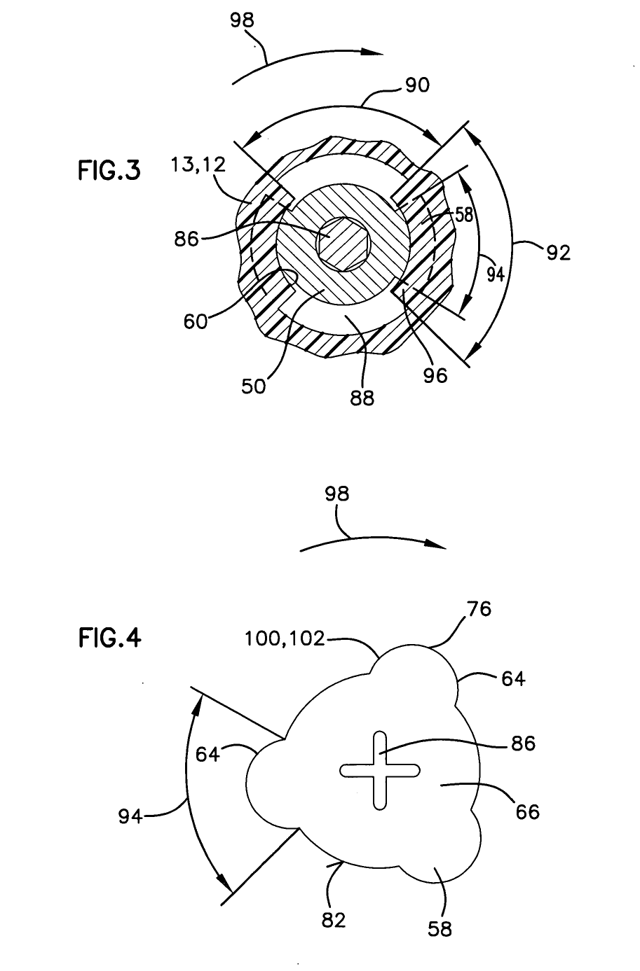

The rotary drive is depicted in FIG. 3 according to a view in accordance with III. The housing 12 has in this instance, for example, a gear assembly housing 13, that is manufactured from plastic by an injection die casting process. A borehole 52 is located in the housing section 13 in the direction of the cylinder axis 62, which has additional auxiliary radial recesses 88 in the housing section 13. In the embodiment example both of the radial recesses 88 extend over an angular range 90 of approximately ninety degrees and lie across from each other in such a fashion, that between both of the recesses 88 corresponding angular ranges 92 are arranged in a circumferential direction that form the inside wall 60 of the borehole 52. When installing the supporting member 50 into the borehole 52 with the radial recesses 88, it is inserted with its radial crosspieces 58 axially into the borehole 52 and is pressed with a contact pressing force 54 against the front face 42 of the rotor 14. During the installation, the rotor shaft 22 is preferably aligned vertically, so that due to its own weight, the rotor 14 rests with its one end 31 on the wall 46 of the housing 12 lying across from the supporting member 50. If a predetermined contact pressing force 54 of the supporting member 50 is reached, it 50 is turned around a certain angle using an installation tool that positively locks in the entrainment member 86—for example into an inside polyhedron. In so doing, the radial crosspieces 58 cut into the housing wall 60 with their self-cutting edge 64. The radial crosspieces 58 extend here over an angular range 94 that is smaller than the angular range 90 of the radial recesses 88, so that upon installation the supporting member 50 can be axially inserted into the borehole 52. Furthermore the angular range 94 of the radial crosspieces 58 is smaller than the angular range 92 of the inner wall 60, so that the radial crosspieces 58 are located after installation completely within the inner wall 60. So that the radial crosspieces 58 are not thereby turned entirely to the next recess 88, a section of the inner wall 60 forms a security area 96, which forms a limit stop above the crosspieces 58. This prevents a further twisting of the output link 50.

A supporting member 50 of an additional embodiment example is depicted in FIG. 4 before its installation into the housing 12. The supporting member 50 has three angular ranges 94 with radial crosspieces 58, between which angular ranges without axial crosspieces 58 are arranged across the circumference 82 of the base plate 60, which are at least exactly as large as those with radial crosspieces. In order to install the supporting member 50, it is turned in the direction of rotation of installation around an angular range, that approximately corresponds to the angular range 94 of the crosspieces 58. In order that the radial crosspieces 58 cut lightly into the inner wall 60, the radial crosspieces 58 have a self-chamfering (self-fluting) edge 64, which during installation comes to rest in the inner wall 60 in the direction of rotation 98. On the edge of the radial crosspieces 58 opposite to the above mentioned self-chamfering edge as seen in a circumferential direction (against the direction of rotation 98), the crosspieces 58 have locking mechanisms 102. The locking mechanisms 102 are, for example, designed as sharp edged ridges 102, which grab tightly into the housing material 12 if the supporting member 50 rotates backwards during operation. The supporting member 50 has a cross slit 86 as an entrainment member in which the corresponding installation tool engages as a form-closure in order to turn it in the direction of rotation. The number of radial crosspieces 58 in a plane 74 is not limited to two or three but can amount to four or more. Likewise the formation of the edges 64 and 102 can be varied especially to accommodate the combination of materials between the radial crosspieces 58 and the housing wall 60 (for example kidney shaped). In so doing, it is extremely important, that the crosspieces 58 in a plane 74 are arranged approximately vertical to the cylinder axis 62 and especially parallel to the stop face 56 (without an upward slope to their circumference 76), as then the axial force acting on the supporting member does not lead to a rotational movement of the supporting element 50. The supporting member 50 is preferably manufactured from metal, whereby the stop face 56 is hardened to increase its service life.

It should be noted, that when considering the many examples of embodiment in all of the depicted figures and accompanying descriptions, many combinations are possible among them. Especially the number and form of the radial crosspieces 58 as well as those of the corresponding recesses 88 can be varied. Furthermore, the number of planes 74 needed to correspond to the axial forces 40 which arise can be varied. Additionally, the front faces 42 are not limited to spherical, arched surfaces, but any desirable stop faces of the rotor 14, respectively the rotor shaft 22 can be formed. In place of the worm 32 other gear assembly components can be positioned on the rotor shaft 22 (as for example a spur gear with straight or slanted outer gearing), which have likewise a head 33 to provide for rotor shaft support. The supporting member 50 can be placed as desired at the gear assembly housing 12 or at the end of the pole pot 16. Such an axial adjustment of the armature according to the invention, which is both self-supporting and free of play, adapts itself especially well for use in regulating drives in the motor vehicle; however, is not limited to this application alone.

1. A rotary drive that adjusts a moving part in a motor vehicle, the rotary drive including a rotor positioned with bearings in a housing, the rotor being supported with at least one front face axially on a supporting member, which is attached via a form closure on the housing, wherein the supporting member has radial crosspieces that can be turned into the housing and thereby create chamfers.

2. The rotary drive according to claim 1, wherein the supporting member has a cylindrically shaped base plate having its own cylinder axis wherein the base plate has an outer circumference where crosspieces are arranged in a plane approximately vertical to the cylinder axis.

3. The rotary drive according to claim 1, wherein the crosspieces are arranged in tangentially spaced intervals and extend over an angular range that consists of a fraction of the outer circumference.

4. The rotary drive according to claim 1, wherein the crosspieces include two crosspieces lying radially opposed to each other and being kidney-shaped, and are positioned around the outer circumference.

5. The rotary drive according to claim 1, wherein the crosspieces are arranged in several planes, which are axially spaced in intervals.

6. The rotary drive according to claim 1, wherein the housing has a through hole with radially formed recesses on a circumference of the through hole, in which crosspieces of the supporting member are inserted axially during installation.

7. The rotary drive according to claim 1, wherein the housing has an attachment area for the supporting member, which is manufactured from a softer material than that of the crosspieces.

8. The rotary drive according to claim 7, wherein the softer material includes plastic, aluminum, magnesium, or zinc.

9. The rotary drive according to claim 1, wherein the crosspieces have a sharp cutting edge that cuts into the housing when turned in a direction of installation, and the crosspieces have a second edge with locking mechanisms.

10. The rotary drive according to claim 9, wherein the locking mechanisms include a ridge that grabs tightly into the housing when turning occurs against the direction of installation.

11. The rotary drive according to claim 1, wherein the front face of the rotor has a radius that rests against a flat stop surface that is formed on the supporting member.

12. The rotary drive according to claim 1, wherein the supporting member, on its side opposite to that which interfaces with a stop face has a form closed entrainment member.

13. The rotary drive according to claim 12, wherein the entrainment member is an inside polyhedron or cross slit that transfers a torque during the installation of the supporting member.
